(19) United States
(12) Patent Application Publication
(10) Pub. No.: US 2024/0119417 A1
(43) Pub. Date: Apr. 11, 2024

(54) SYSTEMS AND METHODS FOR MONITORING ORGANIZATIONAL DYNAMICS AND INCLUSIVITY

(71) Applicant: Lotis Blue Consulting, LLC, Chicago, IL (US)

(72) Inventor: Aaron Sorensen, Northbrook, IL (US)

(21) Appl. No.: 18/477,096

(22) Filed: Sep. 28, 2023

Related U.S. Application Data
(60) Provisional application No. 63/412,141, filed on Sep. 30, 2022.

(51) Int. Cl. G06Q 10/10; G06N 20/00; G06Q 10/0637; G06Q 10/0639

(52) U.S. Cl. CPC G06Q 10/103; G06N 20/00; G06Q 10/06375; G06Q 10/06393; G06Q 10/06398; G06Q 10/105

(57) ABSTRACT

Systems and methods are disclosed for tracking and improving inclusivity in organizations. Collaboration data (e.g., email, conference, phone, and other metadata) and organizational data (e.g., organization hierarchy information) can be used to generate collaboration graphs that depict how members of an organization collaborate with one another. Various collaboration metrics can then be calculated for members and/or groups within the organization. In some cases, business outcome data can be used to identify collaboration features, such as correlations between certain collaboration metrics and current and/or future business outcomes. The collaboration metric(s) and/or model outputs can then be used to initiate various collaboration actions, such as presenting visualizations for interacting with the collaboration metrics, identifying outlie members/groups, presenting notifications and nudges for how inclusion can be improved, and initiating various automated actions to improve inclusion.

### CROSS-REFERENCE TO RELATED APPLICATIONS

The present application claims the benefit of and priority to U.S. Provisional Patent Application No. 63/412,141, filed Sep. 30, 2022, which is hereby incorporated by reference herein in its entirety.

### TECHNICAL FIELD

The present disclosure relates to organizational dynamics generally and more specifically to monitoring and taking actions to improve inclusivity, collaboration and connectedness in organizations.

### BACKGROUND

Inclusivity among members of an organization has been repeatedly shown to improve outcomes for the organization and improve member satisfaction. Different members of an organization can provide different insight and experience to the organization, and may approach creative tasks in different ways. As a result, organizations can benefit from diverse and inclusive interactions.

Many organizations attempt to improve diversity and inclusivity through hiring practices. While such practices are beneficial, it can be difficult to assess and effect organizational inclusivity after members are hired. Furthermore, collaboration and social connections (“connectedness”) are foundational to inclusivity. Without collaboration and connectedness, organizations cannot be inclusive.

### BRIEF SUMMARY

According to some implementations of the present disclosure, a method comprises receiving collaboration data for a plurality of collaborative exchanges between members of an organization. The method further comprises receiving organizational data for the members of the organization. The method further comprises generating collaboration graph data based on the collaboration data and the organizational data. Generating the collaboration graph includes identifying, as nodes, the members of the organization. Generating the collaboration graph further includes identifying, as edges, a plurality of interactions between each of the nodes based on the collaboration data. The method further includes generating one or more collaboration metrics based at least in part on the collaboration graph data. The method further includes automatically initiating a collaboration action based at least in part on the one or more collaboration metrics.

In some cases, generating the collaboration graph data further includes determining an interaction modality for each of the plurality of interactions; and applying a weighting to each of the plurality of interactions based at least in part on the respective interaction modality. In some cases, generating the collaboration graph data further includes determining a plurality of groups based on the organizational data and the identified nodes.

In some cases, automatically initiating the collaboration action includes generating and presenting a visualization based at least in part on the collaboration metrics. In some cases, presenting the visualization includes presenting a graphical user interface depicting i) a group diversity metric; ii) a group inclusion metric; iii) a group diversity ranking; iv) a group inclusion ranking; v) a group diversity distribution; vi) a group inclusion distribution; vii) an accessibility inclusion metric; viii) an age inclusivity metric; ix) a balance metric; x) a connectedness metric; xi) a gender inclusivity metric; xii) a racial ethnic inclusivity metric; xiii) a group assortativity metric; xiv) a tribalism metric; xv) a collaboration graph visualization; or xvi) any combination of i-xv. In some cases, the graphical user interface depicts the collaboration graph visualization, and wherein the collaboration graph visualization includes a visual representation of i) nodes, ii) edges; iii) high-inclusion nodes having inclusion metrics over a threshold maximum value; and iv) low-inclusion nodes having inclusion metrics below a threshold minimum value. In some cases, the method further comprises receiving a view selection, wherein presenting the visualization includes presenting, based on the view selection, i) an organizational overview; ii) a group comparison; iii) a group overview; or iv) an individual member overview.

In some cases, generating the one or more collaboration metrics includes generating i) a demand metric; ii) a reach metric; iii) a connectedness metric; iv) an influence metric; v) a hidden influence metric; vi) a relationship leverage metric; vii) a unification metric; viii) a centrality metric; ix) an inclusion metric; or x) any combination if i-ix. In some cases, generating the one or more collaboration metrics includes generating i) a group accessibility metric; ii) a group connectedness metric; iii) a group relationship strength metric; iv) a group community strength metric; v) a group balance metric; vi) a group tribalism metric; vii) a group gender inclusivity metric; viii) a group racial ethnic inclusivity metric; ix) a group age inclusivity metric; x) a group assortativity metric; or xi) any combination of i-x.

In some cases, the method further comprises receiving business outcome data; identifying one or more correlation features based at least in part on the one or more collaboration metric and the business outcome data; and modelling a future change in the collaboration graph data based at least in part on the identified one or more model features; wherein automatically initiating the collaboration action is further based at least in part on the collaboration features. In some cases, each of the one or more collaboration metrics is associated with a collaboration metric category, and wherein identifying the correlation features includes: performing correlation analysis to compare the one or more collaboration metrics with the business outcome data to identify primary correlations; performing time series analysis to compare the one or more collaboration metrics with the business outcome data with a plurality of time lags to identify time-lagged correlations; and performing feature selection based at least in part on the identified primary correlations and time-lagged correlations.

In some cases, automatically initiating the collaboration action includes: identifying an outlying subset of one or more members from the members of the organization based at least in part on the one or more collaboration metrics; and generating and presenting a notification based at least in part on the identified outlying subset of one or more members. In some cases, the notification includes i) an indication that a member is at risk of leaving the organization ii) an indication that a member is harmful to inclusion at the organization; iii) an indication that a group containing the outlying subset of one or more members is harmful to inclusion at the organization; or iv) any combination of i-iii. In some cases, the notification includes a recommendation to improve inclusivity at the organization, the recommendation including i) a recommendation to encourage collaboration between a member and another member; ii) a recommendation to encourage collaboration between a member and any member of a group; iii) a recommendation to encourage collaboration between a group and another group; iv) a recommendation to adjust membership of one or more groups; or v) any combination of i-iv. In some cases, presenting the notification includes presenting an option to automatically forward the recommendation to i) the member; ii) the group; or iii) leadership of the group to which the recommendation is directed.

In some cases, the method further comprises predicting a future change in the collaboration graph data based at least in part on the one or more collaboration metrics wherein predicting the future change include supplying the collaboration graph data and the one or more collaboration metrics to a machine learning algorithm trained on training data, the training data including historical collaboration graph data and one or more historical collaboration metrics. In some cases, the method further comprises receiving business outcome data; and identifying one or more correlation features based at least in part on the one or more collaboration metrics and the business outcome data; wherein predicting the future change further includes supplying the correlation feature to the machine learning algorithm.

In some cases, automatically initiating the collaboration action includes: determining an automated action to perform based at least in part on the one or more collaboration metrics, wherein the automated action to perform is determined to improve at least one of the one or more collaboration metrics; and automatically performing the automated action. In some cases, determining the automated action includes: identifying an outlying subset of one or more members from the members of the organization based at least in part on the one or more collaboration metrics; selecting an automated action from a group of possible actions; and customizing the automated action based at least in part on the outlying subset of one or more members.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

The specification makes reference to the following appended figures, in which use of like reference numerals in different figures is intended to illustrate like or analogous components.

FIG. 1 is a visualization of a collaboration graph for an organization with a relatively low inclusion metric according to certain aspects of the present disclosure.

FIG. 2 is a visualization of a collaboration graph for an organization with a relatively high inclusion metric according to certain aspects of the present disclosure.

FIG. 3 is a flowchart depicting a process for monitoring organizational dynamics and inclusivity according to certain aspects of the present disclosure.

FIG. 4 is a graphical user interface depicting various collaboration metrics across different teams in an organization according to certain aspects of the present disclosure.

FIG. 5 is a graphical user interface depicting various collaboration metrics across different members of a team in an organization according to certain aspects of the present disclosure.

FIG. 6 is a graphical user interface depicting various collaboration metrics and demographic information across different members of a team in an organization according to certain aspects of the present disclosure.

FIG. 7 is a flowchart depicting a process for predicting member churn in an organization according to certain aspects of the present disclosure.

FIG. 8 is a network graph depicting effectiveness of churn prediction according to certain aspects of the present disclosure.

FIG. 9 is a block diagram of an example system architecture for implementing features and processes of the present disclosure.

### DETAILED DESCRIPTION

Certain aspects and features of the present disclosure relate to systems and methods for tracking and improving inclusivity, collaboration and connectedness in organizations. Collaboration data (e.g., email, meeting, conference, phone, and other metadata), organizational data (e.g., organization hierarchy information and Human Resources/Personnel data) can be used to generate collaboration graphs that depict how members of an organization collaborate with one another. Various collaboration, inclusion and connectedness metrics, hereafter referred to as collaboration metrics, can then be calculated for members and/or groups within the organization. In some cases, business outcome data can be used to identify collaboration features, such as correlations between certain collaboration metrics and current and/or future business outcomes. The collaboration metric(s) and/or model outputs can then be used to initiate various collaboration actions, such as presenting visualizations for interacting with the collaboration metrics, identifying outlie members/groups, presenting notifications and nudges for how inclusion can be improved, and initiating various automated actions to improve inclusion.

In organizations, especially those with many members, such as large corporations with many employees, it has been shown that teams with higher levels of inclusion are able to grow their client relationships about 30% more than those with lower inclusion. Further, improved inclusion can help improve creativity of the overall team. Traditionally, hiring practices are used to promote diversity and inclusion in an organization, but once hiring is completed, it becomes difficult for inclusivity and its effects to be monitored. Further, it may be even more difficult to identify opportunities for improving inclusivity amongst members of an organization.

When it comes to actual team member collaboration, it can be difficult for managers to monitor collaboration patterns and inclusion in their teams. It is especially difficult to monitor inclusivity across different teams in an organization and over long periods of time. Further, relationships and interconnections may exist within an organization that are not able to be tracked through organizational hierarchy structures alone.

Certain aspects and features of the present disclosure permit leadership (e.g., team managers, organization leaders, and the like) to i) identify at-risk individuals before they disengage and potentially quit; ii) identify where inclusion, collaboration, and team cohesion is being challenged, such as aby hybrid work, and impacting the business; iii) illuminate inclusion blind spots that may otherwise go unnoticed; iv) easily improve inclusion through the use of timely notifications and recommendations; v) bring awareness and actionable focus to teams with dysfunctional behaviors that undermine cohesion; and vi) highlight opportunities to reduce silos across the organization and improve collaboration.

Certain aspects and features of the present disclosure relate to systems and methods for tracking collaboration between members of an organization and generating collaboration metrics that can be used to track and improve inclusivity in the organization. Further, certain aspects and features of the present disclosure facilitating showing how various collaboration metrics can improve business outcomes. Collaboration actions can be taken to present visualizations, present notifications (e.g., recommendations), and/or take automated actions to improve collaboration and inclusivity, as well as future business outcomes.

Collaboration graphs can be created from collaboration data, and optionally including organizational data. The collaboration data can include various metadata from various collaboration platforms. Example collaboration platforms include email services, calendar services, phone services, videoconferencing services, room reservation services, and the like. Any metadata suitable for identifying a collaboration between at least two members of the organization can be used as collaboration data. In an example, Microsoft® Graph API can be accessed to obtain metadata associated with email interactions and calendar events in an organization's Microsoft® Outlook instance. In most cases, collaboration data can explicitly exclude the content of collaborations (e.g., the body of an email), although that need not always be the case. The collaboration data can include sufficient information to i) identify when the collaboration took place; ii) identify the participants of the collaboration; and iii) identify the modality of the collaboration. In some cases, collaboration data can further include sufficient information to identify the initiator of the collaboration and/or to identify a general topic or category of the collaboration (e.g., to differentiate whether the collaboration is social or business-related; to differentiate whether the collaboration is associated with a first team or a second team; or to differentiate whether the collaboration is associated with a first project or a second project). In some cases, the collaboration data can further include information indicative of a duration of the collaboration (e.g., duration of a meeting) and the like.

In an example, collaboration data associated with email traffic can include a sender address, a receiver address, a message identifier, a timestamp, an email size (e.g., in bytes), a number of attachments, a number of carbon copy receivers, one or more addresses for carbon copy receivers, a number of blind carbon copy receivers, one or more addresses for blind carbon copy receivers.

In an example collaboration data associated with calendar appointments can include a sender or organizer address, an invitation identifier, a timestamp, an invitation size (e.g., in bytes), a number of attachments, a number of required attendants, one or more addresses for required attendants, a number of optional attendants, one or more addresses for optional attendants, a meeting date and time, a meeting duration, a meeting location, a list of non-declined invites, a list of tentative invitees, a list of declined invitees.

Organizational data can include member data (e.g., information about each member of the organization), group data (e.g., information about the membership of teams or other groups in the organization), and/or hierarchy data (e.g., information about the hierarchical structure of members of the organization). Organizational data can come from a human resources management system or similar source. Member data can include demographic information about the member, such as the member's age, nationality, ethnicity, race, gender, and the like. Any demographic trait to be used in determining inclusivity can be included in the member data.

Examples of organizational data can include, for each member in the organization, i) a member identifier; ii) an email address; iii) a member name; iv) a department or division identifier; v) a department or division description; vi) a job code; vii) a job code description; viii) an alternate job title; ix) a job family code description; x) a job function code description; xi) a job level code description; xii) a job salary grade; xiii) a gender; xiv) an ethnic group; xv) a race; xvi) an age; xvii) disability status; xviii) military status; xix) original hire date; xx) benefit seniority date; xxi) continuous service date; xxii) status (e.g., active or terminated); xxiii) termination date; xxiv) last day worked; xxv) years with the organization; xxvi) time in current role; xxvii) previous role; xxviii) time in previous role; xxix) manager name; xxx) manager status code; xxxi) manager job title; xxxii) manager email address; xxxiii) manager employee identifier; and xxxiv) home office. Other information can be included as well, such as derivatives of any other type of organizational data. For example, in some cases organizational data about an individual can include an indication that individual recently received a promotion or was recently terminated, although in other cases, organizational data about the individual (e.g., the individual's previous job code and current job code) can be analyzed to generate derivative organizational data that is indicative of the individual recently receiving a promotion or recently being terminated. Organizational data can also include information indicative of the organization's hierarchy.

A collaboration graph is directed or non-directed graph used to show collaboration between members of the organization. As used herein, the term collaboration graph is intended to include the collaboration graph data and/or the visualization of the collaboration graph data. A collaboration graph can depict multiple nodes (e.g., members of an organization) and edges between various nodes (e.g., collaborations). The list of nodes and edges can be based on unique pairs of participants (e.g., unique pairs of senders and recipients) found in the collaboration data. In some cases, edges can be weighted based on the collaboration modality. For example, emails between two individuals may be weighted differently than instant messages between those two individuals, which may also be weighted differently than in-person meetings between those two individuals.

In some cases, the collaboration graph data can be used along with the organizational data, such as by merging the organizational data into the collaboration graph data (e.g., member data for each member can be associated with their respective nodes in the collaboration graph).

Various collaboration metrics can then be calculated based on the collaboration graph data. Collaboration metrics can be member-specific, team-specific, or organization-specific. Examples of member-specific collaboration metrics include: i) a demand metric; ii) a reach metric; iii) a connectedness metric; iv) an influence metric; v) a hidden influence metric; vi) a relationship leverage metric; vii) a unification metric; viii) a coreness metric; and ix) an inclusion metric. Member-specific collaboration metrics can be scaled (e.g., on a 0-100 scale) to compare across members.

A demand metric can be based on a number of collaborations directed to a member (e.g., communications sent to the member), with a higher number indicative of more incoming collaborations. Thus, individuals who receive more emails than others may have a higher demand metric than others. The demand metric can be referred to as an in-degree metric.

A reach metric can be based on a number of collaborations initiated by a member (e.g., communications sent by the member), with a higher number indicative of more outgoing collaborations. Thus, individuals who send more emails than others may have a higher reach metric than others. The reach metric can be referred to as an out-degree metric.

A connectedness metric can be based on a total number of connections (e.g., edges) that a member (e.g., node) has. The higher the connectedness metric, the more total connections that member has. The connectedness metric can be referred to as a total degree metric or a total degree centrality metric. This connectedness metric can be based on first-order connections (e.g., direct connections from the given node to another node), which can also be known as neighbors.

An influence metric can be based on a total weight of a member's connections. The weight of a connection between members can be based on a total number of collaborations between the members; a frequency of collaboration between the members; the modality of collaborations between the members; and/or the like. The higher the influence metric, the more influence the member is expected to have in the organization. The influence metric can also be referred to as a weighted degree metric or a weighted degree centrality metric.

A hidden influence metric can be based on the degree of connection to highly connected individuals, which can indicate hidden influence. For example, a member who may not themselves be strongly connected to many other individuals, but who is strongly connected to a highly influential member, may nevertheless have hidden influence within the organization. The higher the hidden influence metric, the more (hidden) influence the member is expected to have in the organization. The hidden influence metric can be referred to as an eigenvalue centrality metric.

A relationship leverage metric can be based on a degree of connection to highly influential nodes beyond one's direct connections. For example, while a member may not have any direct connections with a highly influential member, that first member may nevertheless be strongly connected to many others who are directly connected to the highly influential member. The higher the relationship leverage metric, the more authoritative the member is expected to be. The relationship leverage metric can be referred to as a pagerank centrality metric. This relationship leverage metric can be based on second-order connections (e.g., indirect connections from the given node to another node via an intermediary node) or higher-order connections (e.g., indirect connections from the given node to another node via a plurality of intermediary nodes).

A unification metric can be based on the extent to which one serves as a connector or bridge between two groups (e.g., teams) of members. For example, if two teams are entirely separated except for one member who serves on both teams, that one member may have a very high unification metric. The higher the unification metric, the more of a connector that member may be. In some cases, multiple unification metrics can be calculated for a single member based on that single member's ability to connect different sets of groups. In some cases, however, a single unification metric can be calculated for a member based on that member's ability to act as a connector between at least one set of groups. The unification metric can be referred to as a betweenness metric or a betweenness centrality metric.

A centrality metric can be based on the extent to which one is at the center of a network of members (e.g., the center of a group of members or the center of the organization). The higher the centrality metric, the more core the member is to that network of members. The centrality metric can be referred to as a coreness metric.

An inclusion metric can be based on the unification metric and the influence metric. Optionally, the inclusion metric can be based on any combination of member-specific collaboration metrics. The inclusion metric can be calculated as equally weighting the inverse of the unification metric with the influence metric. The higher the inclusion metric, the more included that member is in the network.

Team-specific or organization-specific metrics can be calculated from the connected graph data and/or any combination of one or more of the member-specific collaboration metrics. Team-specific or organization-specific metrics can be referred to as group-specific metrics, as they are metrics for a particular group of members (e.g., a team of members, an organization of members, or other group of members). Examples of group-specific metrics include i) a group accessibility metric; ii) a group connectedness metric; iii) a group relationship strength metric; iv) a group community strength metric; v) a group balance metric; vi) a group tribalism metric; vii) a group gender inclusivity metric; viii) a group racial ethnic inclusivity metric; ix) a group age inclusivity metric; and x) a group assortativity metric.

A group accessibility metric can be based on the length of the longest path of connections between nodes of the group (e.g., a group diameter). In other words, the distance to connect the two farthest nodes of the group. The group accessibility metric can be calculated as the 1 minus the length of the longest path divided by the total number of nodes in the group. Thus, the higher the group accessibility metric, the more accessible nodes in the group are to one another.

A group connectedness metric can be based on the ratio of the number of edges to the number of possible edges. Groups with higher group connectedness metrics are thus closer to maximizing the total number of possible interconnections between members. Groups with a low group connectedness will likely have opportunities to improve by promoting collaboration between non-connected members. The group connectedness metric can be referred to as a density metric.

A group relationship strength metric can be based on the proportion of mutual connections in a group. As more members of the group have mutual connections with one another, the group relationship strength metric increases, indicating the group is more integrated. Thus, groups with higher group relationship metrics show that the relationships within the group are stronger. The group relationships strength metric can be referred to as a reciprocity metric.

A group community strength metric can be based on a likelihood that adjacent vertices are connected. For example, given a first node, there are a number of connected nodes that are connected to that first node. A ratio can be calculated as the number of those connected nodes that are connected to one another over the total number of possible connections between those connected nodes. Similar ratios can be calculated for all nodes in a given group. These ratios can be used to determine the group community strength metric. A high group community strength metric is indicative of stronger collaboration within the group. The group community strength metric can be referred to as a transitivity metric.

A group balance metric can be based on how central the collaboration graph is. A less centralized group can be indicative of a more balanced group. The group balance metric can be calculated as 1 minus a centralization value for the group. Thus, a higher group balance metric is indicative of stronger collaboration in the group.

A group tribalism metric can be based on how separated a graph is into groups of different individuals. In an example, group tribalism can be calculated based on a modularity score, which can be based on a number of edges within clusters of nodes relative to an expected number of edges by chance. A higher modularity score is indicative that the group is separated into clusters, and thus less integrated. The group tribalism metric can be calculated as 1 minus the modularity score. Thus, a higher group tribalism metric is indicative of a more integrated group (e.g., fewer clusters), whereas a low group tribalism metric is indicative that the network is separated into unconnected clusters, or “tribes.”

A group gender inclusivity metric can be based on the tendency for individuals of the same gender to collaborate. Demographic information from the organizational information can be used to associate each node with its respective gender. A score between −1 and 1 can be calculated (e.g., as a correlation between node attributes) to determine a tendency of members to communicate with members of the same gender such that a score closer to 1 is indicative of a strong tendency to connect with individuals of the same gender and a score closer to −1 is no tendency to connect with individuals of the same gender. The group gender inclusivity metric can be calculated as −1 multiplied by that score. Thus, a positive group gender inclusivity metric is indicative more gender inclusivity, whereas a negative group gender inclusivity metric is indicative of less gender inclusivity.

A group racial/ethnic inclusivity metric can be based on the tendency for individuals of the same ethnic group or race to collaborate. Demographic information from the organizational information can be used to associate each node with its respective ethnic group or race. A score between −1 and 1 can be calculated to determine a tendency of members to communicate with members of the same ethnic group or race such that a score closer to 1 is indicative of a strong tendency to connect with individuals of the same ethnic group or race and a score closer to −1 is no tendency to connect with individuals of the same ethnic group or race. The group ethnic/race inclusivity metric can be calculated as −1 multiplied by that score. Thus, a positive group ethnic/race inclusivity metric is indicative more ethnic/race inclusivity, whereas a negative group race inclusivity metric is indicative of less ethnic/race inclusivity.

A group age inclusivity metric can be based on the tendency for individuals of the same age group to collaborate. Demographic information from the organizational information can be used to associate each node with its respective age or age group. An age group can be defined as a life age of an individual in years (e.g., 39 years old), a life age range for the individual (e.g., 35-39 years old), a tenure for the individual (e.g., a member of the organization for 3 years), a tenure range for the individual (e.g., a member of the organization for 2-4 years), or the like. A score between −1 and 1 can be calculated to determine a tendency of members to communicate with members of the same age group such that a score closer to 1 is indicative of a strong tendency to connect with individuals of the same age group and a score closer to −1 is no tendency to connect with individuals of the same age group. The group age inclusivity metric can be calculated as −1 multiplied by that score. Thus, a positive group age inclusivity metric is indicative more age group inclusivity, whereas a negative group age inclusivity metric is indicative of less age group inclusivity.

Other inclusivity metrics can be determined similarly to the group gender inclusivity metric, group racial/ethnic inclusivity metric, and group age inclusivity metric, but with different differentiating factors. Specific types of inclusivity metrics can be based on differentiating individuals based on any suitable factors, such as demographic factors obtained from the organizational data and/or detected collaboration patterns. For example, a remote worker inclusivity metric can be based on the tendency for individuals who are not remote workers to collaborate with other individuals who are not remote workers.

A group assortativity metric can be based on the tendency for individuals to associate with others who share similar characteristics. The group assortativity metric can thus be based on a single characteristic (e.g., gender, in which the group assortativity metric would match the group gender inclusivity metric) or a combination of two or more characteristics, such as some or all available characteristics.

In some cases, other metrics can be calculated as collaboration metrics. In some cases, collaboration metrics can be calculated for individuals (e.g., members), groups (e.g., teams or organizations), sub-groups (e.g., sub-groups within a team), and the like. Teams of members can be based on defined teams (e.g., teams defined by the organizational data) or apparent teams (e.g., identified clusters of individuals within the collaboration graph).

In some cases, in addition to collaboration data and organizational data, business outcome data can be leveraged. Business outcome data can be received from any suitable source, such as sales tools and customer relationship management systems. Business outcome data can be indicative of and/or can be used to generate one or more business outcome metrics. Business outcome metrics can be used to evaluate the success of the business. Examples of business outcome metrics include financial metrics (e.g., revenue growth, costs, profit), customer results metrics (e.g., new customer metrics, customer retention metrics, customer growth metrics, lifetime value metrics, satisfaction and/or net promotor score metrics), people outcome metrics (e.g., engagement metrics, performance metrics, turnover metrics, career growth and mobility metrics), and operational efficiency metrics (e.g., productivity metrics, decision making metrics, efficiency metrics). Any suitable business outcome metric can be used.

A correlation analysis can be performed to compare collaboration metrics with business outcomes. For example, a correlation analysis can be performed to identify correlations between a group connectedness metric and a sales metric, or a group tribalism metric and a turnover metric. Any combination of one or more collaboration metrics can be correlated with any combination of one or more business outcome metrics. Correlations that surpass a threshold can be used.

A time series analysis can be performed to evaluate correlations between collaboration metrics and business outcomes at different time lags, such as ranging from 1 month to 12 months prior, although other time lag periods can be used. For example, if it is determined that a group gender inclusivity metric is correlated with a client engagement metric, the time series analysis can determine the time lag associated with this correlation. For example, it may be determined that an increase in group gender inclusivity metric is associated with an increase in client engagement metric within three months.

Correlation features can then be selected based on the collaboration metrics and time lags that are most highly correlated to the business outcome metrics. These correlation features can be used to identify which collaboration metrics would need to be improved to achieve desired improvements in business outcome metrics (e.g., within a certain time period). These correlation features can also be used to predict future changes in business outcome metrics based on current or recent changes in collaboration metrics. Thus, recent, current, or future changes in the collaboration graph (e.g., due to membership changes, team changes, or changes in collaboration patterns), can be tied to expected changes in business outcome metrics.

In some cases, the correlation features can be used to identify members and/or groups (e.g., teams) at risk of turnover. For example, if correlation features are associated with business outcome metrics indicative of member turnover or group turnover, recent, current, or future changes in the collaboration metrics can be used to model whether or not an individual and/or group may be at risk of turnover given the changes.

In some cases, the system can make use of a machine learning algorithm trained by using compositional modeling to predict how a network is likely to change over time given a particular change (e.g., the addition of a new member). Leveraging this machine learning algorithm, the system can make useful predictions to guide collaboration actions.

The system can take various collaboration actions based on collaboration metrics, model outputs, and/or business outcome metrics. A collaboration action can be an action designed to facilitate assessing or improving a collaboration metric.

In an example, the collaboration metrics can be used to generate and present a visualization, such as a visualization of the collaboration graph and/or visualizations of the various collaboration metrics. In some cases, the visualization is a graphical user interface (GUI). The GUI can present visualizations, and in some cases, allow a user to interact with the visualizations. For example, a user may be able to apply filters to the data to alter the visualizations. In some cases, providing combinations of certain collaboration metrics together can permit advanced functionality that allows a user to better understand the inclusivity of an individual, a team, or an organization. Further, in some cases, a visualization of the collaboration graph can be provided, which can help depict opportunities for improvement to improve business performance and/or inclusivity.

In some cases, business outcome metrics can be included in the GUI. Presenting business outcome metrics in the GUI along with collaboration metrics can allow a user to quickly and easily visualize how changes in the collaboration graph may affect business metrics. In some cases, the GUI can receive user input to model a prospective change in the collaboration graph. The prospective change can be based on user input, based on a planned action in the organizational data (e.g., a planned start date for a new member or planned end date for a departing member), or based on a recommendation and/or automated action, as described in further detail herein. When modeled, the prospective change can show the expected changes in collaboration metrics and/or business outcome metrics.

In some cases, the system can use the collaboration metrics(s), model outputs, and/or business metrics, optionally with additional data (e.g., collaboration data, organizational data, business outcome data, and/or collaboration graph data) to generate and present a notification. The notification can be notice of an issue that is arising (e.g., a warning that a member or group has a collaboration score that is beyond a threshold, such as above a maximum threshold, below a minimum threshold, outside of a threshold range, or inside of a threshold range); a recommendation for an action (e.g., a recommendation to encourage collaboration between two members); or any other suitable notification. The notification can be presented to the user via any suitable technique, such as presentation on a display device (e.g., a monitor), transmission through a collaboration platform (e.g., sent as an email or text message), presented by a non-visual presentation device (e.g., haptic feedback via a haptic feedback generator, audio presentation via a speaker, or the like), or otherwise presented.

In some cases, a recommendation can be determined based on the current collaboration graph or a modeled future change in the collaboration graph. For example, if the current collaboration graph shows that a member is likely at risk of turnover, the recommendation may include taking actions that are associated with collaboration metrics expected to lower the member's risk of turnover. For example, an individual feeling siloed from others in the organization may be at risk of turnover, and the recommendation may be to increase collaboration between that individual and other members. The recommendation may be presented immediately or in a scheduled fashion. In some cases, the recommendation may be provided to a manager or other leader of the organization, although that need not always be the case. In some cases, the recommendation may be provided to the member for whom the recommendation is made. For example, the recommendation may be in the form of an email recommending that the member reach out to another member to collaborate on a project.

In some cases, the system can perform automated actions based on the collaboration metric(s), model outputs, and/or other business outcome metrics, optionally with additional data. The automated actions can be designed to improve a collaboration metric and/or a business outcome metric, which can include improving a collaboration metric that is expected to improve a business outcome metric. The automated action can be selected from a list of possible automated actions. The selected automated action can depend on the collaboration metric (and/or business outcome metric) to be improved, the individual to whom the action is directed, an individual involved in the action, or the like. Once selected, the automated action can be customized for the desired recipient or member to whom the action is directed. In an example, taking an automated action can include automatically presenting a recommendation to a user, such as via an email communication. In another example, taking an automated action can include automatically inviting a set of members to an event (e.g., automatically issuing a calendar invite based on the set of members), such as to promote collaboration between those members.

In some cases, actions taken based on the collaboration metric(s), model outputs, and/or business outcome metrics can be based on an identified subset of one or more members that are identified as outliers. For example, one or more members may be identified as outliers due to having an unusually low inclusion metric (e.g., below a threshold value). Once that subset of outlier members is identified, the actions taken can be taken to improve the collaboration metric(s) of the members of that subset of outlier members. For example, if the system identifies member X as an outlier, it may automatically initiate delivery of a recommendation to member X suggesting that they collaborate with a particular other member more.

Overall, aspects and features of the present disclosure are especially useful at improving how collaboration data and organizational data is stored and accessed, especially for purposes of assessing and improving inclusivity in organizations. Further, certain aspects and features of the GUI permit a user to interact with collaboration metrics in new and useful ways that can permit users to better understand inclusion within the organization and easily identify opportunities for improvement. Certain aspects and features of the present disclosure provide for a significant improvement in how inclusivity in organizations can be assessed and improved.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe implementations of the present disclosure.

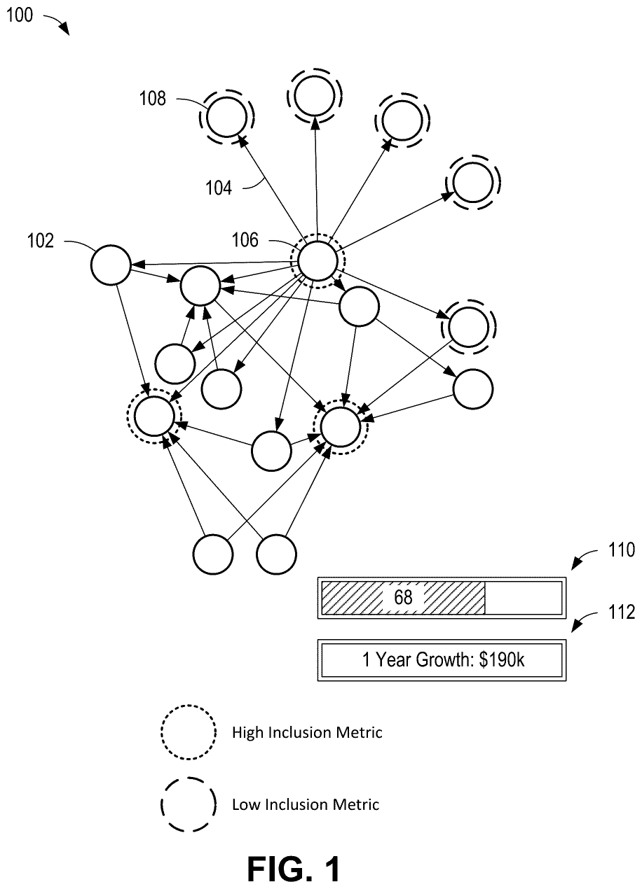

FIG. 1 is a visualization of a collaboration graph 100 for an organization with a relatively low inclusion metric according to certain aspects of the present disclosure. The collaboration graph 100 shows a number of nodes 102 each connected by edges 104. Each node 102 can represent a member of the organization. Each edge 104 can represent a collaboration connection between the two nodes 102. The collaboration connection can be indicative of at least one or at least a threshold number of collaboration events between the members represented by the nodes 102. For example, sending an email to another member or inviting the other member to a meeting may qualify as a collaboration event. In some cases, edges 104 can be weighted based on the number of collaboration events, the frequency of collaboration events, the modality of the collaboration event (e.g., email, calendar invite, instant message, phone call, etc.), or other differentiable factors.

As disclosed herein, collaboration metrics can be determined for the members of an organization. Each node 102 in the collaboration graph 100 can have an associated inclusion metric, as disclosed herein. In some cases, when the inclusion metric associated with the node 102 is over an upper threshold value, the node 102 can be indicated as a high inclusion metric node 106 via a visually discernable feature (e.g., highlighting, halos, color changes, etc.). As depicted in FIG. 1, the visually discernable feature is a dotted circle surrounding the high inclusion metric node 106. Similarly, when the inclusion metric associated with the node 102 is below a lower threshold value, the node 102 can be indicated as a low inclusion metric node 108 via a visually discernable feature (e.g., highlighting, halos, color changes, etc.). As depicted in FIG. 1, the visually discernable feature is a dashed circle surrounding the high inclusion metric node 108.

In some cases, a group inclusion metric 110 and/or a business outcome metric 112 can be depicted along with the collaboration graph 100. As depicted in FIG. 1, the group inclusion metric 110 has a value of 68 (e.g., 68 out of 100) and the business outcome metric 112 of 1 year growth has a value of $190k. As depicted in FIG. 1, the moderate group inclusion metric is associated with a moderate 1 year growth.

In some cases (not depicted), each node 102 can further include, such as within the shape of the node, additional information, such as a node identifier (e.g., a member identifier) or other information pertaining to the node (e.g., the inclusion metric for that node).

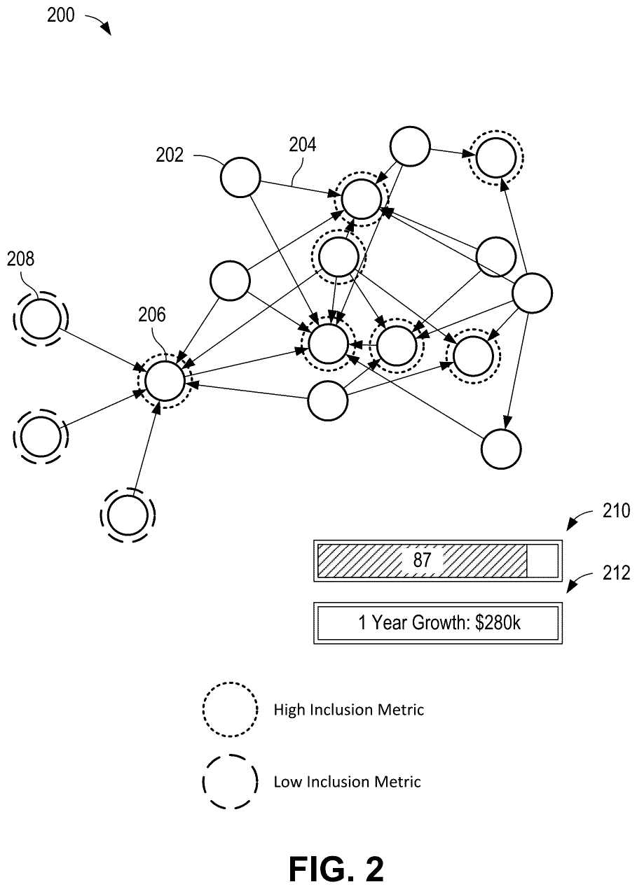

FIG. 2 is a visualization of a collaboration graph 200 for an organization with a relatively high inclusion metric according to certain aspects of the present disclosure. The collaboration graph 200 shows a number of nodes 202 each connected by edges 204. Each node 202 can represent a member of the organization. Each edge 204 can represent a collaboration connection between the two nodes 202. The collaboration connection can be indicative of at least one or at least a threshold number of collaboration events between the members represented by the nodes 202.

As disclosed herein, collaboration metrics can be determined for the members of an organization. Each node 202 in the collaboration graph 200 can have an associated inclusion metric, as disclosed herein. In some cases, when the inclusion metric associated with the node 202 is over an upper threshold value, the node 202 can be indicated as a high inclusion metric node 206 via a visually discernable feature (e.g., highlighting, halos, color changes, etc.). As depicted in FIG. 2, the visually discernable feature is a dotted circle surrounding the high inclusion metric node 206. Similarly, when the inclusion metric associated with the node 202 is below a lower threshold value, the node 202 can be indicated as a low inclusion metric node 208 via a visually discernable feature (e.g., highlighting, halos, color changes, etc.). As depicted in FIG. 2, the visually discernable feature is a dashed circle surrounding the high inclusion metric node 208.

In some cases, a group inclusion metric 210 and/or a business outcome metric 212 can be depicted along with the collaboration graph 200. As depicted in FIG. 2, the group inclusion metric 210 has a value of 87 (e.g., 87 out of 100) and the business outcome metric 212 of 1 year growth has a value of $280k. As depicted in FIG. 2 compared with FIG. 1, the higher group inclusion metric is associated with a higher 1 year growth.

In some cases (not depicted), each node 202 can further include, such as within the shape of the node, additional information, such as a node identifier (e.g., a member identifier) or other information pertaining to the node (e.g., the inclusion metric for that node).

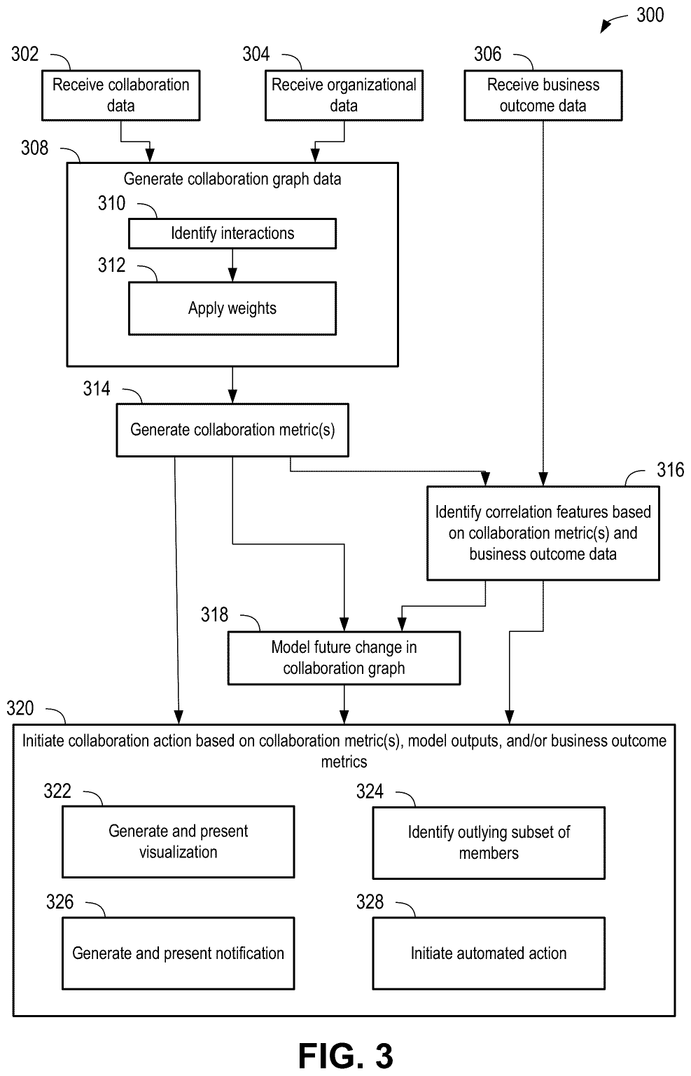

FIG. 3 is a flowchart depicting a process 300 for monitoring organizational dynamics and inclusivity according to certain aspects of the present disclosure.

At block 302, collaboration data is received. Receiving collaboration data can include obtaining collaboration data from one or more sources, such as via one or more application programming interfaces (APIs). Receiving the collaboration data can include accessing metadata from various forms of collaboration and storing the metadata in a database. In some cases, metadata that is out of scope (e.g., involves non-members of the organization) can be ignored or removed. In some cases, receiving the collaboration data includes transforming raw data inputs into a common format. In some cases, receiving collaboration data includes accessing or generating keys to join records from different data sources. For example, a unique key can be generated for each member of the organization, which can be used to correlate collaboration events associated with that member.

At block 304, organizational data can be received. Receiving organizational data can include receiving member data, group data, and/or hierarchy data associated with an organization. Receiving organizational data can include obtaining organizational data from one or more sources, such as via one or more APIs. In some cases, receiving the organizational data includes transforming raw data inputs into a common format. In some cases, receiving organizational data includes accessing or generating keys to join records from different data sources. For example, a unique key can be generated for each member of the organization, which can be used to correlate organizational data associated with that member.

At block 308, collaboration graph data can be generated. Generating collaboration graph data can include generating a collaboration graph. Generating collaboration graph data can include using the collaboration data, and optionally the organizational data, to generate a network graph of collaboration throughout the organization. Generating collaboration graph data can include generating a node and edge list. Generating the node and edge list can include identifying interactions at block 310. Identifying interactions can include identifying unique pairs of senders and recipients based on the collaboration data. The unique pairs of senders and recipients can define the nodes and edges of the collaboration graph data.

In some cases, generating collaboration graph data at block 308 can include applying weights at block 312. The weights applied at block 312 can be based on the interaction modality, although that need not always be the case. Weights can be applied to each interaction and/or each edge based on the modality of the interactions. For example, an interaction via email can have a different weight associated with it than an interaction via instant message.

In some cases, generating the collaboration graph data at block 308 can include joining organizational data from block 304 with collaboration data from block 302. Joining the organizational data can include associating organizational with its respective node in the collaboration graph data. For example, a node may be associated with a particular member, in which case joining the organizational data can include associating organizational data for that particular member with the given node. Organizational data can include member data (e.g., demographic data about the individual), group data (e.g., information about what teams or other groups to which the member belongs), and/or hierarchy data (e.g., information about how the member fits into the hierarchical structure of the organization, such as a job title and job hierarchy information).

In some cases, generating the collaboration graph data at block 308 can include defining one or more groups within the organization. The one or more groups can be defined based on received organizational data (e.g., departments or teams as defined by the organization) or can be based on an analysis of the nodes and edges of the collaboration graph data. In some cases, the collaboration graph data generated at block 308 can include multiple subsets of collaboration graph data for each of the defined groups (e.g., teams).

At block 314, one or more collaboration metrics can be generated. Collaboration metrics can be generated based on the collaboration graph data from block 308. Generating the collaboration metrics at block 314 can include generating at least one member-specific metric and at least one group-specific metric. Generating a member-specific metric can include generating i) a demand metric; ii) a reach metric; iii) a connectedness metric; iv) an influence metric; v) a hidden influence metric; vi) a relationship leverage metric; vii) a unification metric; viii) a coreness metric; ix) an inclusion metric; or x) any combination of i-ix. Generating a group-specific metric can include generating i) a group accessibility metric; ii) a group connectedness metric; iii) a group relationship strength metric; iv) a group community strength metric; v) a group balance metric; vi) a group tribalism metric; vii) a group gender inclusivity metric; viii) a group racial ethnic inclusivity metric; ix) a group age inclusivity metric; x) a group assortativity metric; or xi) any combination of i-x. Any of these collaboration metrics can be calculated as described in further detail herein.

In some cases, generating collaboration metrics at block 314 includes generating at least a unification metric, an influence metric, and an inclusion metric for each node in the collaboration graph data. In some cases, generating collaboration metrics at block 314 includes generating at least a group diversity metric and a group inclusivity metric. The group diversity metric can be indicative of the diversity of the membership of a given group (e.g., a team or an organization). The group diversity metric can be based on any suitable diversity differentiators, such as any suitable demographic factor (e.g., age, race, ethnic group, gender, and the like). In some cases, the group diversity metric is a combination of other diversity metrics, such as a group age inclusivity metric, a group gender inclusivity metric, and/or a group racial ethnic inclusivity metric. For example, the group diversity metric can be a weighted sum of multiple diversity metrics, such as:

$$GroupDiversity = \frac{{I}_{age}}{3} + \frac{{I}_{gender}}{3} + \frac{{I}_{racial\_ethnic}}{3} ,$$

wherein I_{age} is the group age inclusivity metric, I_{gender} is the group gender inclusivity metric, and I_{racial_ethnic} is the group racial ethnic inclusivity metric. Weights can be based on the number of diversity metrics used, and may or may not be the same across all diversity metrics.

In some cases, at block 306, business outcome data can be received. Receiving business outcome data can include obtaining business outcome data from one or more sources, such as via one or more application programming interfaces (APIs). Receiving the business outcome data can include accessing data or metadata from various sources and storing the information in a database. In some cases, receiving the business outcome data includes transforming raw data inputs into a common format. In some cases, receiving business outcome data includes accessing or generating keys to join records from different data sources. For example, a unique key can be generated for a particular client of the organization, which can be used to correlate different business outcome data associated with that client.

In some cases, receiving business outcome data at block 306 can include generating business outcome metrics. For example, in some cases business outcome data can provide numerous data points that can be analyzed to generate a single business outcome metric. In some cases, however, the received business outcome data already includes a business outcome metric.

At block 316, correlation features can be identified based on collaboration metric(s) and the business outcome data. Identifying correlation features can include identifying one or more combinations of collaboration metric(s) and business outcome metric(s) that are sufficiently correlated. In some cases, a correlation analysis can be performed to compare collaboration metrics with business outcome metrics. Highly correlated relationships can be identified and poorly correlated relationships ignored. Correlations identified by correlation analysis can be known as primary correlations. A time series analysis can be performed to evaluate correlations between collaboration metrics and business outcome metrics across different time lags. Any suitable time lags can be used (e.g., 1 month to 12 months). The result of the time series analysis can be the identification of correlations between changes in collaboration metrics at a first time and correlated changes in business outcome metrics at a later time, or vice versa. The correlations identified by the time series analysis can be known as time-lagged correlations. Feature selection can then be performed using the collaboration metrics and time lags that are most highly correlated to desired business outcome metrics. These features, which can be known as correlation features, can be used to train and apply data to models for modeling changes in the collaboration graph (e.g., the effect on business outcome metrics that comes from a change in the collaboration graph, or the change in the collaboration graph expected after a change in business outcome metrics).

In some cases, a future change in the collaboration graph can be modeled at block 318. Modeling the future change can include using the collaboration metric(s), and optionally the identified correlation features from block 316. A model can be generated based on an analysis of historical (e.g., past) collaboration data and historical business outcome data. For example, the collaboration data and business outcome data for last year can be used to train a machine learning algorithm, optionally based on the identified correlation features. Once trained, the machine learning algorithm can be used to model what effect a change in the collaboration graph may have in the future. For example, the adding or removal of a member to or from the organization may have effects down the line, such as effects on business outcome metrics (e.g., sales) and effects on collaboration metrics (e.g., affecting group inclusivity metrics). In some cases, a desired business outcome metric can be set, and possible actions to take to change the collaboration graph (e.g., hire a new member or promote collaboration between existing members) that would result in that desired business outcome metric can be obtained. The output from block 318 can be referred to as a model output.

In some cases, modeling a future change in the collaboration graph at block 318 can include performing a logistic regression using the correlation features to identify individuals and/or groups that are most at risk for turnover.

At block 320, a collaboration action can be initiated based at least in part on the collaboration metric(s) from block 314, the model outputs from block 318, and/or business outcome metrics from block 306. In some cases, the collaboration action is initiated based at least in part on the collaboration metric(s). Initiating the collaboration action can include taking an action designed to improve collaboration within the organization.

In some cases, initiating the collaboration action at block 316 includes generating and presenting a visualization at block 322. The visualization can be a visualization of the collaboration graph data, a visualization of the collaboration metric(s), a visualization of the model outputs, and/or a visualization of the business outcome metrics. In some cases, generating and presenting the visualization can include presenting a GUI, as disclosed in further detail herein. The visualization can be presented using any suitable presentation device, such as a display device (e.g., computer monitor or smartphone screen).

In some cases, initiating the collaboration action at block 320 includes identifying an outlying subset of members at block 324. Identifying the outlying subset of members can include identifying members having one or more collaboration metrics that fall outside of desired thresholds. In some cases, identifying the outlying subset of members can include identifying members that are at risk of turnover, such as from the model outputs from block 318. The outlying subset of members can include one or more members. Once identified, the outlying subset of members can be displayed (e.g., presented in a visualization at block 322), used in a notification as described below with reference to block 326, used to initiate an automated action as described below with reference to block 328, and/or otherwise used to initiate a collaboration action.

In some cases, initiating the collaboration action at block 320 includes generating and presenting a notification at block 326. Generating and presenting the notification can include creating and outputting (e.g., via a display device or other output device) a notification directed to an individual. The notification can be directed to a recipient, such as a manager or team leader. The notification can be regarding a subject, which can be a member, a group, or the like. For example, a notification warning that member X is at risk of turnover can be directed to member Y, who may be member X's supervisor. Upon receiving the notification, member Y can take appropriate action to try and retain member X and/or otherwise improve member X's enjoyment in the organization. In some cases, the recipient and subject of the notification can be the same, such as if a notification is sent to member X to recommend collaborating with member Z more.

Notifications can indicate an area of improvement, such as the possibility of improve one or more collaboration metrics and/or one or more business outcome metrics; can indicate a potential future event (e.g., a potential future change in the collaboration graph, such as turnover of an employee, such as identified by model outputs from block 318); can be a recommendation, or any other suitable type of notification.

When the notification is a recommendation, the recommendation can be selected to improve one or more collaboration metrics and/or business outcome metrics. For example, the system can determine that sales may be improved if Team A had improved connectedness, and therefore issue a recommendation designed to reduce the length of the longest path of connections within Team A, such as by suggesting that certain members of Team A collaborate together. In use, a manager may be able to take this recommendation and make assignments designed to promote collaboration between the designated members, which improves the connectedness of Team A, with the goal of improving sales.

In some cases, initiating the collaboration action at block 320 can include initiating an automated action at block 328. Initiating the automated action at block 328 can involve automatically taking an action, such as automatically assigning a member to a project or automatically creating and sending a calendar invite involving a set of members. The action initiated at block 328 can be selected from a group of possible actions based on the desired outcome, the collaboration metric(s), the model outputs, and/or the business outcome metrics. For example, if it is determined that sales can be improved if Team A had improved connectedness, the system may automatically create and send out a calendar invite including certain members of Team A, with the goal of promoting collaboration between the selected members. In some cases, automated actions at block 328 can be taken without any user input. In some cases, however, the automated actions can proceed only after receiving confirmation from a designated user (e.g., a manger). In such cases, the system may request confirmation to perform the automated action, providing information about the automated action and its desired effect, which the designated user can approve or deny.

In some cases, initiating an automated action at block 328 can include determining an adjustment to a setting and implementing the adjustment. In some cases, the setting can be a collaboration setting that is associated with one or more members of the organization. Adjusting the collaboration setting can include adjusting how future collaboration data is collected (e.g., adding a new source of collaboration data, such as text messages, or removing an existing source of collaboration data, such as calendar entries). In some cases, adjusting a collaboration setting can include adjusting how at least one member is able to collaborate with others (e.g., restricting calendar invite access between users, or automatically pre-populating certain draft collaborations, such as emails, with select members' contact information). Various other settings can be adjusted. In some cases, adjusting a setting can include adjusting a security setting associated with one or more members of the organization. For example, if the future change from block 318 is that a member is likely to leave the organization, a security setting can be adjusted to automatically increase monitoring of that member's activities, including collaborations or non-collaboration activities.

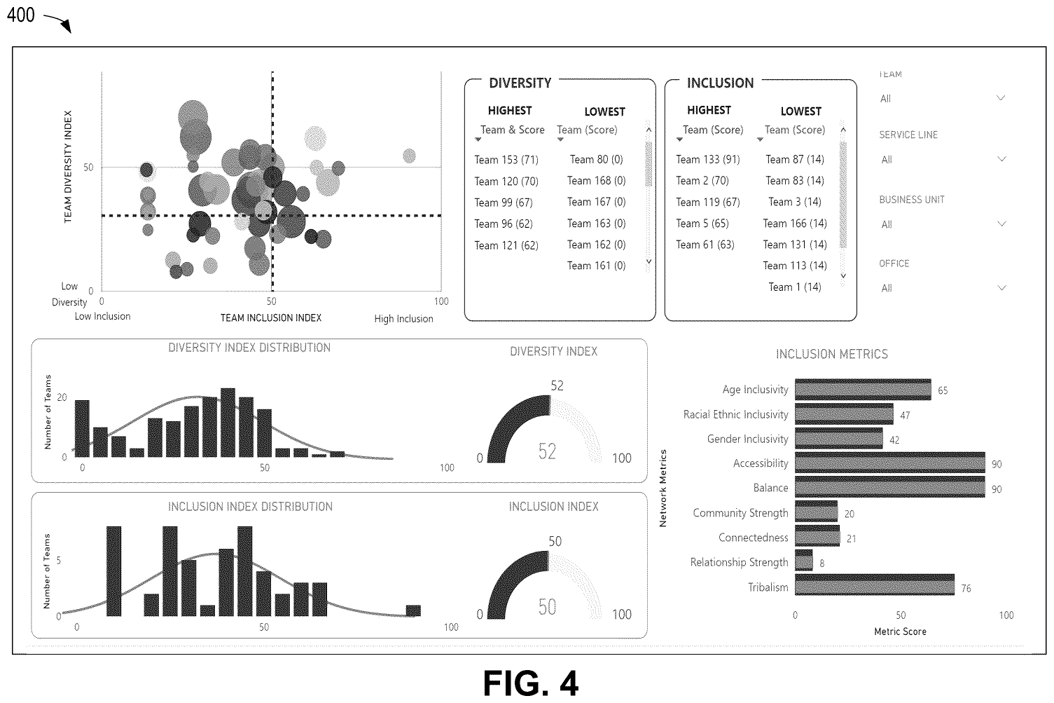

FIG. 4 is a graphical user interface 400 depicting various collaboration metrics across different teams in an organization according to certain aspects of the present disclosure. In this organizational overview view, various organization-level information can be depicted. As depicted in FIG. 4, GUI 400 includes a scatter plot of team inclusion index (e.g., a group inclusion metric) versus team diversity index (e.g., a group diversity metric), Each bubble represents a team in the organization, with the size of the bubbles representing the number of members on the team. The placement of the bubbles within the plot show how diverse and inclusive each team is.

GUI 400 further includes a set of tables with top and bottom rankings for the group diversity metric and the group inclusion metric. The teams with the highest and lowest rankings of diversity and inclusion are depicted, along with their scores (e.g., the value of the respective metric).

GUI 400 further includes a set of histograms showing the number of teams at various buckets of values for the team diversity index and team inclusion index. In some cases, an average diversity index and/or inclusion index for the selected team(s) and/or organization can be shown.

GUI 400 further includes a set of bar charts with various inclusion metrics comparing the selected team(s) to the organization's average. As depicted in FIG. 4, since all teams are selected, the metrics of the selected team(s) matches that of the organization's average.

In some cases (not depicted), GUI 400 can further include a count of the total number of selected teams (e.g., total number of teams in the organization, or fewer if a subset of teams are selected for viewing and/or a subset of teams are filtered out) and employees.

In some cases, GUI 400 can include a set of filters to filter out specific teams, departments, business units, office locations, or the like. As depicted in FIG. 4, GUI 400 includes filters for team, service line, business unit, and office. In some cases, a user can interact with any of the features of the GUI (e.g., the bubbles in the scatter plot, the teams listed in the tables, the bars on the histogram) to filter by the team(s) associated with the selected feature. For example, clicking on the “Team 121 (62)” item in the table would filter the other features of GUI 400 to show metrics associated with Team 121.

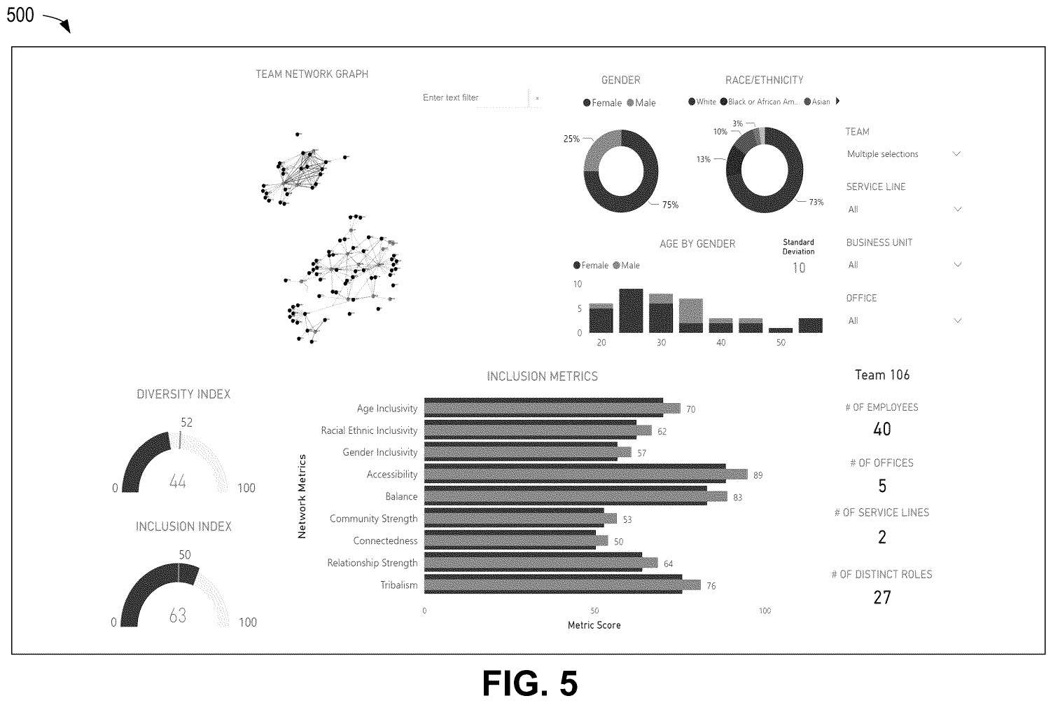

FIG. 5 is a graphical user interface 500 depicting various collaboration metrics across different members of a team in an organization according to certain aspects of the present disclosure. In this team comparison view, various team-level information can be depicted.

As depicted in FIG. 5, GUI 500 includes a network graph visualization depicting the edges and nodes in the network of the selected team(s). The network graph visualization can identify nodes by various filters, such as demographic filters. In some cases, selecting parts of the network graph will filter the other charts on the page to the selected groups.

GUI 500 can include a table ranking the top and bottom teams by any suitable metric, such as a group diversity metric or a group inclusion metric.

GUI 500 can include a bar chart with side by side comparison of all teams by various inclusivity metrics, such as a group inclusion metric, a gender inclusion metric, a race inclusion metric, and an age inclusion metric. In some cases, the bar chart can compare the selected team(s) with the organizational averages for those metrics. For example, the selected team depicted in FIG. 5 appears to be outperforming the organizational averages in each of the depicted inclusion metrics.

GUI 500 can include specific information about the makeup of the team, such as the total number of members in the team, the number of offices across which the members of the team are spread, the total number of service lines or departments across which the members of the team are spread, and the total number of distinct roles associated with the members of the team.

GUI 500 can include a breakdown of the selected team(s) by gender, ethnic group, race, or any combination of these or other demographic features.

In some cases, GUI 500 can include a set of filters to filter out specific teams, departments, business units, office locations, or the like. As depicted in FIG. 5, GUI 500 includes filters for team, service line, business unit, and office. In some cases, a user can interact with any of the features of the GUI (e.g., clusters on the network graph visualization) to filter by the group(s) associated with the selected feature. For example, clicking on one of the cluster in the network graph visualization can filter the other features of GUI 500 to show metrics associated with only members of that cluster. In some cases, a cluster can be a single team, although that need not always be the case.

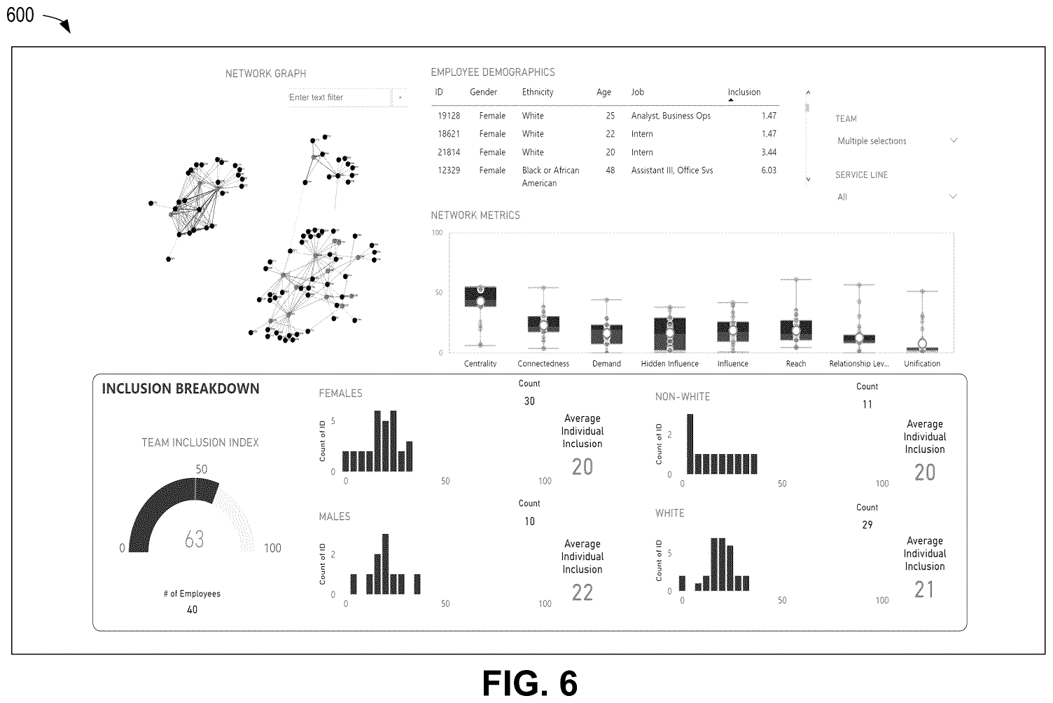

FIG. 6 is a graphical user interface 600 depicting various collaboration metrics and demographic information across different members in an organization according to certain aspects of the present disclosure. In this member view, various member-level information can be depicted for the team.

As depicted in FIG. 6, GUI 600 includes a network graph visualization depicting the edges and nodes in the network associated with the selected member(s). In some cases, the network graph visualization depicts only the nodes of the selected member(s), as well as any edges between those nodes. In some cases, the network graph visualization can include nodes of the selected member(s) as well as any nodes to which those selected member(s) are directly connected by an edge, as well as edges between the shown nodes. The network graph visualization can identify nodes by various filters, such as demographic filters. In some cases, selecting parts of the network graph will filter the other charts on the page to the selected groups.

GUI 600 can include a table depicting the selected employee(s) and their demographic information and individual inclusion metric. Employees may be identified by an identification number, which can optionally be anonymized and displayed without the employee's name or other identifying information.

GUI 600 can include a distribution of the collaboration metrics for the selected employee(s), optionally compared to the team or organization averages. For example, the distribution can include a centrality metric, a connectedness metric, a demand metric, a hidden influence metric, an influence metric, a reach metric, a relationship leverage metric, and a unification metric. Other combinations can be used.

GUI 600 can include a visualization of the inclusion metric for the selected employee(s), optionally compared to the team or organization average.

GUI 600 can include a set of histograms of the selected employee(s) according to gender, race, ethnic group, age, or the like.

In some cases, GUI 600 can include a set of filters to filter out specific teams, departments, business units, office locations, or the like. As depicted in FIG. 6, GUI 600 includes filters for team and service line. In some cases, a user can interact with any of the features of the GUI (e.g., items in the table of employees and demographic information) to filter by the member(s) associated with the selected feature. For example, clicking on one of the items in the employee demographics table can filter the other features of GUI 600 to show metrics associated with only that employee.

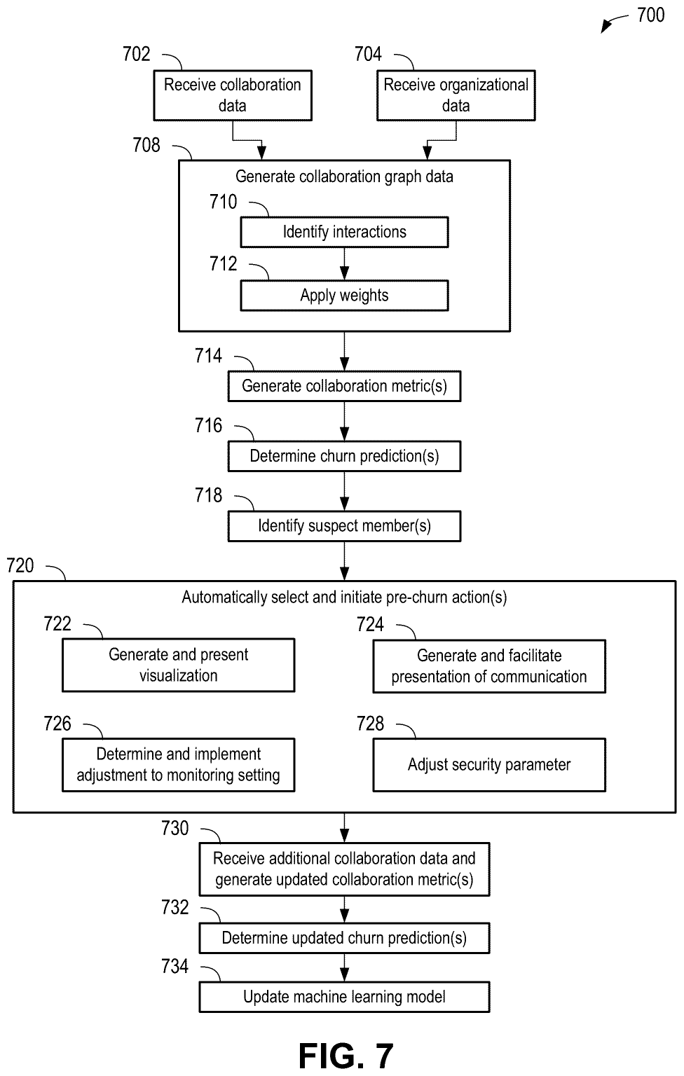

FIG. 7 is a flowchart depicting a process 700 for predicting member churn in an organization according to certain aspects of the present disclosure. Process 700 can operate similarly to process 300. For example, blocks 702, 704, 708, 710, 712, 714 can operate similar to or the same as blocks 302 ,304, 308, 310, 312, 314 from FIG. 3.

At block 702, collaboration data is received, similar to or the same as block 302 of FIG. 3.

At block 704, organizational data is received, similar to or the same as block 304 of FIG. 3.

At block 708, collaboration graph data is generated, similar to or the same as block 308 of FIG. 3.

At block 710, interactions are identified, similar to or the same as block 310 of FIG. 3.

At block 712, weights are applied, similar to or the same as block 312 of FIG. 3.

At block 714, one or more collaboration metrics are generated, similar to or the same as block 314 of FIG. 3.

At block 716, one or more churn predictions can be generated. Churn predictions can be generated for a single member or for a group of members. A churn prediction is an indication of a likelihood that the member or group of members will leave the organization. The churn prediction can include information about whether the member or group of members is expected to leave the organization through voluntary or involuntary (e.g., termination) means. In some cases, a churn prediction can include information about an expected time or period of time in which the member or group of members is expected to leave the organization. For example, the churn prediction can include an exact time (e.g., expected to leave on April 11), an exact time range (e.g., expected to leave within 15 days of April 11), or a relative time range (e.g., expected to leave within the next 120 days). The churn prediction can include a value indicative of the likelihood of the underlying churn event (e.g., member leaving the organization) occurring, such as a “75% likelihood of the member leaving in the next 120 days”). In some cases, a churn prediction can include a number of sub-predictions, each of which can be made for an individual over a number of time periods, such as a separate sub-prediction for each day over the next 60 days indicating the likelihood that the member will leave by that date.

In some cases, a churn prediction can include information about the likelihood of a member leaving a group of an organization (and remaining in the organization) as opposed to leaving the organization entirely.

Generating the churn prediction can include applying the one or more collaboration metrics to a machine learning model that is trained using training data. The training data can include collaboration metrics as input data and churn information as output data. Churn information can include information about a member in the training data who has experienced a churn event, such as the type of churn event (e.g., voluntary exit or termination), the date of the churn event, and the like. Once trained, the machine learning model can take the one or more collaboration metrics as input and can output a churn prediction, which can include a likelihood of a member experiencing a churn event in a given period of time. In some cases, the churn prediction can include a confidence value indicative of the degree of confidence of the prediction.

In some cases, training the machine learning model can include performing elastic net regression on model features to address collinearity and feature selection.

At block 718, one or more suspect members is identified based on the churn predictions. Members from the organization that have a sufficiently high churn prediction can be identified as suspect members. For example, members having a churn prediction above a maximum churn threshold (e.g., 75% likelihood) may be considered suspect members. Suspect members can be those members of the organization that are especially likely to leave the organization in the near future. Suspect members can be those members for whom additional action may be desired to be taken prior to the churn event.

At block 720, one or more pre-churn actions can be automatically selected and initiated. Selecting and initiating the pre-churn action can be based simply on identification of a suspect member, such that once a suspect member is identified, a particular pre-churn action is taken. In some cases, however, selecting and initiating the pre-churn action can be based at least in part on the churn prediction for that suspect member and/or on the collaboration metrics from block 714 associated with that suspect member. In some cases, selecting and initiating a pre-churn action at block 720 can be similar to initiating a collaboration action at block 320 of FIG. 3.

The pre-churn action can be selected to i) decrease the likelihood of the given suspect member leaving the organization; ii) mitigate negative impact to the organization resulting from the given suspect member leaving the organization; or iii) a combination of i and ii.

Various pre-churn actions can be taken. In some cases, such as at block 722, a visualization (e.g., graphical user interface) is generated and presented to indicate the suspect member. Generation and presentation of this graphical user interface can enable an organizational leader to quickly and easily see those members of the organization that are likely to leave in the near future. Generation and presentation of a visualization at block 722 can be similar to or the same as block 322 of FIG. 3.

In some cases, at block 724, a communication can be generated and presentation of the communication can be facilitated. Generation and facilitation of presentation of the communication can allow the communication to be automatically presented to the suspect member, another member or members working with the suspect member, a supervisor of the suspect member, other leadership of the organization, or anyone else to whom such a communication may be beneficial. Such a communication can include an encouragement to collaborate between the suspect member an another member of the organization, an encouragement to collaborate between the suspect member and any member of a group of the organization, and/or any other encouragements to improve the likelihood of the suspect member staying at the organization and not leaving. For example, for a member who is steadily siloed from other members, that member may experience dissatisfaction in their membership with the organization, and may desire to leave, in which case the automatic pre-churn action that is selected and initiated can be an email message that is generated and presented (e.g., sent) to the suspect member encouraging that suspect member to reach out to a particular other member to collaborate. In a similar situation, the email message may instead be generated and presented (e.g., sent) to a supervisor of the suspect member encouraging that supervisor to engage the suspect member more in group activities. Other communications can be generated and presented.

In some cases, at block 726, an adjustment to a monitoring setting can be determined and implemented. The monitoring setting can be any setting associated with monitoring the suspect member. For example, to save bandwidth and processing power, a system may collect and use less than all collaboration data available to the system, however once a suspect member has been identified, the system may collect and use more (e.g., all) of the available collaboration data. As an example, while the system may not normally monitor phone call metadata (e.g., incoming and outgoing numbers, times, and call length) for all members, when a suspect member is identified, the system may start monitoring phone call metadata associated with that suspect member to gain a better understanding of the suspect member's collaboration with others. In such an example, it may be the case that the suspect member simply prefers collaborating using the telephone, and once the telephone metadata is incorporated into the collaboration data used to generate collaboration graph data and collaboration metrics, that suspect member may no longer have a high likelihood of churn and thus may no longer be considered a suspect member.

In some cases, at block 728, an adjustment to a security parameter can be determined and implemented. Adjusting a security parameter can include adjusting any parameter associated with the member's access to organizational resources (e.g., deactivating or increasing logging/notification of the member's network login and physical access keys) or use of organizational resources (e.g., deactivating the ability to copy files to a portable drive or deactivating the ability to send files outside of the organization).

In some cases, selecting and initiating a pre-churn action at block 720 can include selecting the pre-churn action from a list of possible pre-churn actions. In some cases, selecting the pre-churn action can include using a trained machine learning model to select a pre-churn action based on input data, such as the collaboration metrics from block 714. Such a machine learning model can be trained using training data including historical collaboration data involving prior members of the organization and historical organizational data. The historical organizational data can include churn information for each of the prior members of the organization.

In some cases, selecting and initiating the pre-churn action can include initially selecting a pre-churn action and then customizing the selected pre-churn action based at least in part on the suspect member. For example, information in the organizational data and/or other information associated with the suspect member (e.g., human resources information) can be leveraged to alter or adjust a pre-churn action.

In some cases, selecting and initiating a pre-churn action can include automatically adding the suspect member to a group of the organization, such as adding the suspect member to a mailing list associated with a group of the organization.

In some cases, at block 730, additional collaboration data can be received and updated collaboration metric(s) can be generated similar to blocks 702 and 714. The one or more updated collaboration metrics can be used to determine one or more updated churn predictions at block 723 similar to block 716. The updated churn prediction can be used to further classify or reclassify the suspect member. In some cases, the updated churn prediction can be used to automatically select and initiate, in a manner similar to block 720, a subsequent pre-churn action that is different from the pre-churn action selected and initiated at block 720.

In some cases, at block 734, the machine learning model can be updated (e.g., further trained) based on the updated churn predictions. Thus, the machine learning model can be continuously updated based on the efficacy of the pre-churn action(s) selected and initiated at block 720.

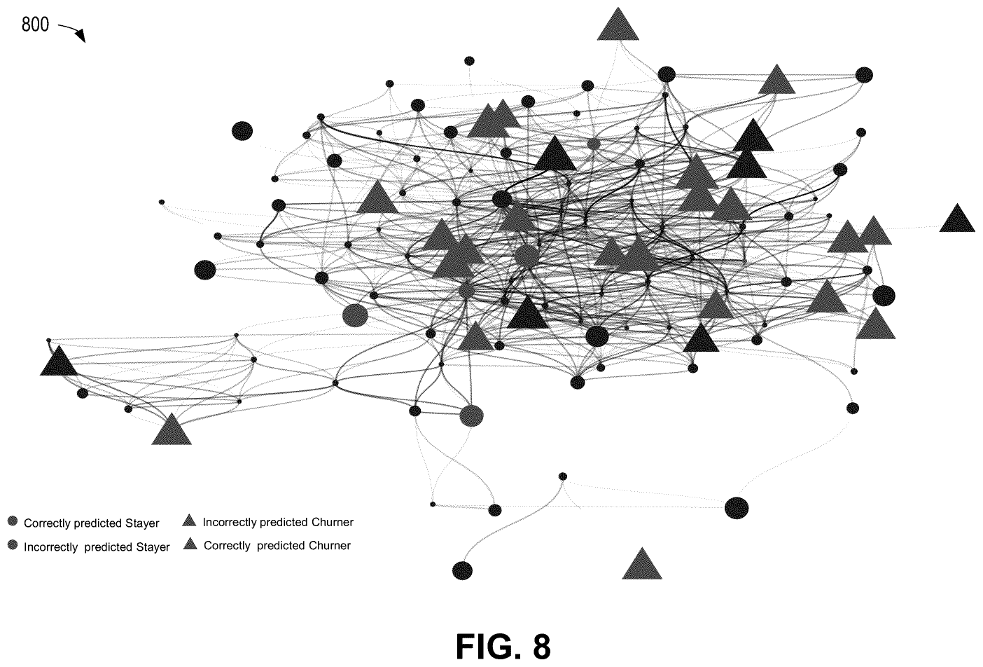

FIG. 8 is a network graph 800 depicting effectiveness of churn prediction according to certain aspects of the present disclosure. The network graph 800 is based on a set of experimental data. A portion of the experimental data (data associated with 70% of the members of the test organization) was used to train a system (e.g., train a model for generating churn predictions) performing a process similar to or the same as process 700 of FIG. 7. Then, holdout data (the remaining 30% of the members of the organization) from the set of experimental data was evaluated using the trained system. This holdout data is depicted in the network graph 800, with circular nodes representing stayers (e.g., individuals who did not leave the organization in the given time frame) and triangular nodes representing churners (e.g., individuals who experienced a churn event in the given time frame).

The blue-colored nodes represent those nodes that were predicted as staying, whereas the red-colored nodes represent those nodes that were predicted as churners (e.g., identified as suspect members, such as described with reference to block 718 of FIG. 7). Thus, blue circular nodes and red triangular nodes represent correct predictions, whereas red circular nodes and blue triangular nodes represent incorrect predictions. In the holdout sample, the number of true negatives (blue circular nodes) was 667, the number of false negatives (red circular nodes) was 65, the number of false positives (blue triangular nodes) was 74, and the number of true positives (red triangular nodes) was 139. The probability decision threshold was set to 0.50.

Relative size of the nodes represents the confidence in the prediction. Thus, the extent of ineffective predictions by the model is evidenced by smaller red circles (e.g., incorrect non-churn predictions; false negatives with overconfidence) and larger blue triangles (e.g., incorrect churn predictions; false positives with overconfidence).

As depicted in FIG. 8, there are many more larger red triangles than larger blue triangles, and many more smaller blue circles than smaller red circles, thus showing the strong prediction quality of the trained system.

For the experimental data used to generate the network graph 800 of FIG. 8, the area under the receiver operating characteristic (ROC) curve was 0.88; the area under the precision-recall (PR) curve was 0.65 (2.92 times better than the base rate of churn); the true positive rate (recall) was 0.68; the true negative rate was 0.90; the balanced accuracy was 0.79; the positive predictive value (precision) was 0.65; the negative predictive value was 0.91; and the F1 score was 0.667. The areas under the ROC and PR curves were generated across all probability decision thresholds from a probability of 0 to a probability of 1. The remaining statistical metrics were generated for a probability decision threshold of 0.5.

Overall, it is seen that the trained model is able to predict member churn quite well based on just collaboration metrics. Further, it is seen that the model is able to well-balance the prediction of churners and stayers.

Further, it has been determined that the accuracy of the trained model is able to predict churn accurately at least up to 120 weeks before the churn event. Using the aforementioned experimental data, prediction accuracy was tested for different time horizons extending up to 120 weeks. For each of these time frames, the prediction accuracy of the trained model remained between 66.7% and 76.7%. Thus, the trained model was able to predict churn both 15 weeks out and 120 weeks out with high accuracy.

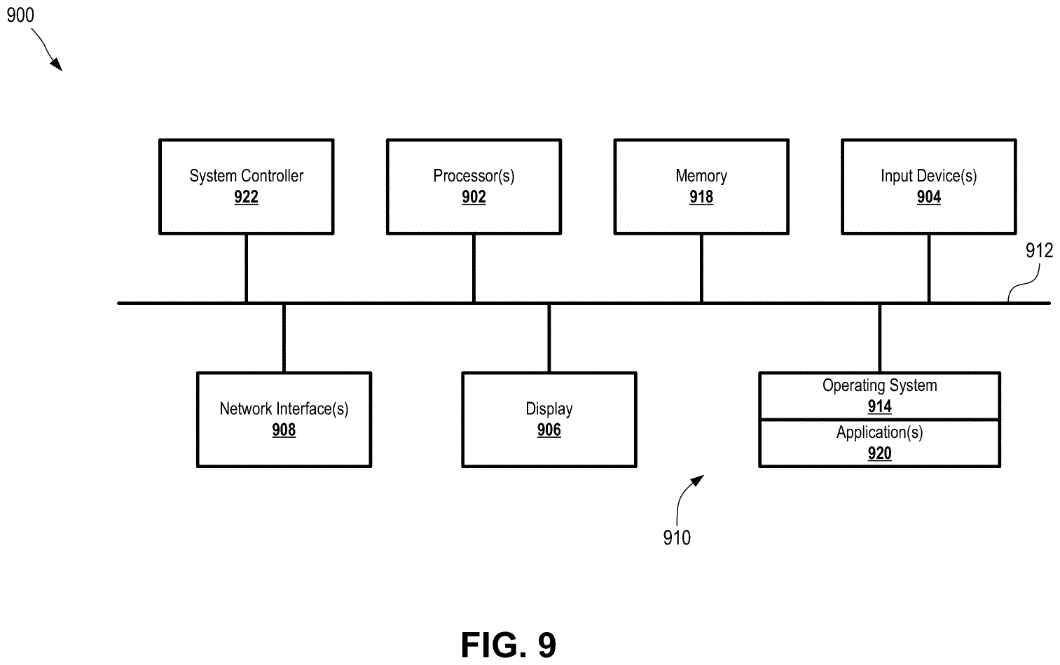

FIG. 9 is a block diagram of an example system architecture 900 for implementing features and processes of the present disclosure, such as those presented with reference to processes 300 and 700 of FIGS. 3 and 7, respectively. The architecture 900 can be used to implement a server, a user device, a computing device, or any other suitable device for performing some or all of the aspects of the present disclosure. The architecture 900 can be implemented on any electronic device that runs software applications derived from compiled instructions, including without limitation personal computers, servers, smart phones, electronic tablets, game consoles, email devices, and the like. In some implementations, the architecture 900 can include one or more processors 902, one or more input devices 904, one or more display devices 906, one or more network interfaces 908, and one or more computer-readable mediums 910. Each of these components can be coupled by bus 912.

Display device 906 can be any known display technology, including but not limited to display devices using Liquid Crystal Display (LCD) or LED technology. Processor(s) 902 can use any known processor technology, including but not limited to graphics processors and multi-core processors. Input device 904 can be any known input device technology, including but not limited to a keyboard (including a virtual keyboard), mouse, track ball, and touch-sensitive pad or display. In some cases, audio inputs can be used to provide audio signals, such as audio signals of an individual speaking. Bus 912 can be any known internal or external bus technology, including but not limited to ISA, EISA, PCI, PCI Express, NuBus, USB, Serial ATA or FireWire.

Computer-readable medium 910 can be any medium that participates in providing instructions to processor(s) 902 for execution, including without limitation, non-volatile storage media (e.g., optical disks, magnetic disks, flash drives, etc.) or volatile media (e.g., SDRAM, ROM, etc.). The computer-readable medium (e.g., storage devices, mediums, and memories) can include, for example, a cable or wireless signal containing a bit stream and the like. However, when mentioned, non-transitory computer-readable storage media expressly exclude media such as energy, carrier signals, electromagnetic waves, and signals per se.

Computer-readable medium 910 can include various instructions for implementing operating system 914 and applications 920 such as computer programs. The operating system can be multi-user, multiprocessing, multitasking, multithreading, real-time and the like. The operating system 914 performs basic tasks, including but not limited to: recognizing input from input device 904; sending output to display device 906; keeping track of files and directories on computer-readable medium 910; controlling peripheral devices (e.g., storage drives, interface devices, etc.) which can be controlled directly or through an I/O controller; and managing traffic on bus 912. Computer-readable medium 910 can include various instructions for implementing firmware processes, such as a BIOS. Computer-readable medium 910 can include various instructions for implementing any of the processes described herein, including but not limited to, at least processes 300 and 700 of FIGS. 3 and 7, respectively.

Memory 918 can include high-speed random access memory and/or non-volatile memory, such as one or more magnetic disk storage devices, one or more optical storage devices, and/or flash memory (e.g., NAND, NOR). The memory 918 (e.g., computer-readable storage devices, mediums, and memories) can include a cable or wireless signal containing a bit stream and the like. However, when mentioned, non-transitory computer-readable storage media expressly exclude media such as energy, carrier signals, electromagnetic waves, and signals per se. The memory 918 can store an operating system, such as Darwin, RTXC, LINUX, UNIX, OS X, WINDOWS, or an embedded operating system such as VxWorks.

System controller 922 can be a service processor that operates independently of processor 902. In some implementations, system controller 922 can be a baseboard management controller (BMC).

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computing system that includes a back-end component, such as a data server, or that includes a middleware component, such as an application server or an Internet server, or that includes a front-end component, such as a client computer having a graphical user interface or an Internet browser, or any combination thereof. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a network. The relationship of client and server arises by virtue of computer programs running on the respective computers and having a client-server relationship to each other.

One or more features or steps of the disclosed implementations can be implemented using an application programming interface (API). An API can define one or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, and the like.

The foregoing description of the implementations of the present disclosure, including illustrated implementations and examples, has been presented only for the purpose of illustration and description and is not intended to be exhaustive or limiting to the precise forms disclosed. Numerous modifications, adaptations, and uses thereof will be apparent to those skilled in the art. Numerous changes to the disclosed implementations can be made in accordance with the present disclosure, without departing from the spirit or scope of the present disclosure. Thus, the breadth and scope of the present disclosure should not be limited by any of the above described implementations.

Although certain aspects and features of the present disclosure have been illustrated and described with respect to one or more implementations, equivalent alterations and modifications will occur or be known to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application.

One or more elements or aspects or steps, or any portion(s) thereof, from one or more of any of the claims below can be combined with one or more elements or aspects or steps, or any portion(s) thereof, from one or more of any of the other claims below or combinations thereof, to form one or more additional implementations and/or claims of the present disclosure.

1. A method comprising:
receiving collaboration data for a plurality of collaborative exchanges between members of an organization;
receiving organizational data for the members of the organization;
generating collaboration graph data based on the collaboration data and the organizational data, wherein generating the collaboration graph includes:
identifying, as nodes, the members of the organization;
identifying, as edges, a plurality of interactions between each of the nodes based on the collaboration data;
generating one or more collaboration metrics based at least in part on the collaboration graph data; and
automatically initiating a collaboration action based at least in part on the one or more collaboration metrics.

2. The method of claim 1, wherein generating the collaboration graph data further includes:
determining an interaction modality for each of the plurality of interactions; and
applying a weighting to each of the plurality of interactions based at least in part on the respective interaction modality.

3. The method of claim 1, wherein generating the collaboration graph data further includes determining a plurality of groups based on the organizational data and the identified nodes.

4. The method of claim 1, wherein automatically initiating the collaboration action includes generating and presenting a visualization based at least in part on the collaboration metrics; and wherein presenting the visualization includes presenting a graphical user interface depicting i) a group diversity metric; ii) a group inclusion metric;
iii) a group diversity ranking; iv) a group inclusion ranking; v) a group diversity distribution; vi) a group inclusion distribution; vii) an accessibility inclusion metric; viii) an age inclusivity metric; ix) a balance metric; x) a connectedness metric; xi) a gender inclusivity metric; xii) a racial ethnic inclusivity metric; xiii) a tribalism metric; xiv) a collaboration graph visualization; or xv) any combination of i-xiv.

5. The method of claim 4, wherein the graphical user interface depicts the collaboration graph visualization, and wherein the collaboration graph visualization includes a visual representation of i) nodes, ii) edges; iii) high-inclusion nodes having inclusion metrics over a threshold maximum value; and iv) low-inclusion nodes having inclusion metrics below a threshold minimum value.

6. The method of claim 1, wherein generating the one or more collaboration metrics includes generating i) a demand metric; ii) a reach metric; iii) a connectedness metric; iv) an influence metric; v) a hidden influence metric; vi) a relationship leverage metric; vii) a unification metric; viii) a centrality metric; ix) an inclusion metric; or x) any combination if i-ix.

7. The method of claim 1, wherein generating the one or more collaboration metrics includes generating i) a group accessibility metric; ii) a group connectedness metric; iii) a group relationship strength metric; iv) a group community strength metric; v) a group balance metric; vi) a group tribalism metric; vii) a group gender inclusivity metric; viii) a group racial ethnic inclusivity metric; ix) a group age inclusivity metric; x) a group assortativity metric; or xi) any combination of i-x.

8. The method of claim 1, further comprising:
receiving business outcome data;
identifying one or more model features based at least in part on the one or more collaboration metric and the business outcome data; and
modeling a future change in the collaboration graph data based at least in part on the identified one or more model features;
wherein automatically initiating the collaboration action is further based at least in part on the modeled future change.

9. The method of claim 8, wherein each of the one or more collaboration metrics is associated with a collaboration metric category, and wherein identifying the correlation features includes:
performing correlation analysis to compare the one or more collaboration metrics with the business outcome data to identify primary correlations;
performing time series analysis to compare the one or more collaboration metrics with the business outcome data with a plurality of time lags to identify time-lagged correlations; and
performing feature selection based at least in part on the identified primary correlations and time-lagged correlations.

10. The method of claim 1, wherein automatically initiating the collaboration action includes:
identifying an outlying subset of one or more members from the members of the organization based at least in part on the one or more collaboration metrics; and
generating and presenting a notification based at least in part on the identified outlying subset of one or more members.

11. The method of claim 10, wherein the notification includes i) an indication that a member is at risk of leaving the organization ii) an indication that a member is harmful to inclusion at the organization; iii) an indication that a group containing the outlying subset of one or more members is harmful to inclusion at the organization; or iv) any combination of i-iii.

12. The method of claim 10, wherein the notification includes a recommendation to improve inclusivity at the organization, the recommendation including i) a recommendation to encourage collaboration between a member and another member; ii) a recommendation to encourage collaboration between a member and any member of a group; iii) a recommendation to encourage collaboration between a group and another group; iv) a recommendation to adjust membership of one or more groups; or v) any combination of i-iv.

13. The method of claim 12, wherein presenting the notification includes presenting an option to automatically forward the recommendation to i) the member; ii) the group; or iii) leadership of the group to which the recommendation is directed.

14. The method of claim 1, further comprising predicting a future change in the collaboration graph data based at least in part on the one or more collaboration metrics wherein predicting the future change include supplying the collaboration graph data and the one or more collaboration metrics to a machine learning algorithm trained on training data, the training data including historical collaboration graph data and one or more historical collaboration metrics.

15. The method of claim 14, further comprising
receiving business outcome data; and
identifying one or more correlation features based at least in part on the one or more collaboration metrics and the business outcome data;
wherein predicting the future change further includes supplying the correlation feature to the machine learning algorithm.

16. The method of claim 1, wherein automatically initiating the collaboration action includes:
determining an automated action to perform based at least in part on the one or more collaboration metrics, wherein the automated action to perform is determined to improve at least one of the one or more collaboration metrics; and
automatically performing the automated action.

17. The method of claim 16, wherein determining the automated action includes:
identifying an outlying subset of one or more members from the members of the organization based at least in part on the one or more collaboration metrics;
selecting an automated action from a group of possible actions; and
customizing the automated action based at least in part on the outlying subset of one or more members.

18. The method of claim 16, wherein automatically initiating the collaboration action includes:
determining an adjustment to a collaboration setting associated with at least one member of the members of the organization; and
implementing the adjustment to the collaboration setting, wherein implementation of the adjustment alters i) how future collaboration data is collected; ii) how the at least one member is able to collaboration with others; or iii) a combination of i and ii.

19. A system comprising:
a control system including one or more processors; and
a memory having stored thereon machine readable instructions;
wherein the control system is coupled to the memory, and the method of claim 1 is implemented when the machine executable instructions in the memory are executed by at least one of the one or more processors of the control system.

20. A computer program product embedded in a non-transitory computer readable medium and comprising instructions which, when executed by a computer, cause the computer to carry out the method of claim 1.

21. A method comprising:
receiving collaboration data for a plurality of collaborative exchanges between members of an organization;
receiving organizational data for the members of the organization;
generating collaboration graph data based on the collaboration data and the organizational data, wherein generating the collaboration graph includes:
identifying, as nodes, the members of the organization; and
identifying, as edges, a plurality of interactions between each of the nodes based on the collaboration data;
generating one or more collaboration metrics based at least in part on the collaboration graph data;
determining, for at least one member of the members of the organization, a churn prediction based at least in part on the one or more collaboration metrics, the churn prediction indicative of a likelihood of the given member leaving the organization;
identifying one or more suspect members from the members of the organization based at least in part on the at least one churn prediction; and
automatically selecting and initiating a pre-churn action in response to identifying each of the one or more suspect members, the pre-churn action selected to i) decrease the likelihood of the given suspect member leaving the organization; ii) mitigate negative impact to the organization resulting from the given suspect member leaving the organization; or iii) a combination of i and ii.

22-23. (canceled)

24. The method of claim 21, wherein selecting the pre-churn action is based at least in part on the one or more collaboration metrics.

25. The method of claim 21, wherein automatically initiating the pre-churn action for a given suspect member includes generating and facilitating presentation of a communication to the given suspect member, the communication i) encouraging collaboration between the given suspect member and another member of the organization; ii) encouraging collaboration between the given suspect member and any member of a group of the organization; or iii) a combination of i and ii.

26. The method of claim 21, wherein automatically initiating the pre-churn action for a given suspect member includes:
determining an adjustment to a monitoring setting associated with the given suspect member; and
implementing the adjustment to the monitoring setting.

27. The method of claim 21, further comprising:
receiving additional collaboration data associated with the given suspect member based at least in part on the monitoring setting;
generating one or more updated collaboration metrics based at least in part on the additional collaboration data; and
determining an updated churn prediction for the given suspect member based at least in part on the one or more updated collaboration metrics.

28. The method of claim 27, wherein automatically selecting and initiating the pre-churn action is based at least in part on a trained machine learning model, the method further comprising:
comparing the churn prediction for the given suspect member with the updated churn prediction for the given suspect member; and
further training the trained machine learning model based at least in part on the comparison between the churn prediction and the updated churn prediction.

29. The method of claim 21, wherein determining the churn prediction includes applying the one or more collaboration metrics to a machine learning model, the machine learning model trained using training data including historical collaboration data involving prior members of the organization and historical organizational data, the historical organizational data including churn information for each of the prior members of the organization.

30. The method of claim 21, wherein automatically selecting and initiating the pre-churn action includes adjusting a security parameter associated with the given suspect member.

31-37. (canceled)

38. The method of claim 21, wherein automatically selecting and initiating the pre-churn action includes, for each of the suspect members:
selecting the pre-churn action from a set of possible pre-churn actions based at least in part on the churn prediction; and
customizing the selected pre-churn action based at least in part on the given suspect member.

39. A system comprising:
a control system including one or more processors; and
a memory having stored thereon machine readable instructions;
wherein the control system is coupled to the memory, and the method of claim 21 is implemented when the machine executable instructions in the memory are executed by at least one of the one or more processors of the control system.

40. (canceled)
